(19) United States
(12) Patent Application Publication
(10) Pub. No.: US 2008/0252776 A1
(43) Pub. Date: Oct. 16, 2008

(54) CAMERA MODULE

(75) Inventors: CHUN-FANG CHENG, Tu-Cheng (TW); PAI-HSIANG CHENG, Tu-Cheng (TW); SSU-HAN HUANG, Tu-Cheng (TW); FU-YEN TSENG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/861,656

(22) Filed: Sep. 26, 2007

(30) Foreign Application Priority Data
Apr. 10, 2007 (CN) 200710200416.8

(51) Int. Cl. H04N 5/225

(52) U.S. Cl. 348/375; 348/E05.024

(57) ABSTRACT

A camera module (100) configured to connect to an outer circuit board includes a lens barrel (12), a holder (14) and a sensing chip (20). The holder has a first end (141), an opposite second end (142). The first end defines a cavity (143) therethrough, and the lens barrel is engaged in the cavity of the first end. The second end defines an opening (144) communicating with the cavity. The sensing chip is attached to the second end thereby sealing the opening defined by the second end. The sensing chip has a back surface (21) away from the first end of the holder, and the back surface is provided with a plurality of welding spots (201) configured for connecting the sensing chip to the outer circuit board electrically and structurally.

### BACKGROUND

1. Field of the Invention

The present invention relates to camera modules and, particularly, to a small-sized camera module.

2. Description of Related Art

Nowadays, camera modules are now in widespread use. Camera modules are being combined with various portable electronic devices such as mobile phones, PDAs (personal digital assistants) and computers to be increasingly multi-functional. Furthermore, such camera modules are needed to satisfy requirements of small size, low cost, and excellent optical performance. However, due to limited space in the camera modules, these requirements are hard to meet.

Referring to FIG. 4, a typical camera module is shown. The camera module includes a flexible printed circuit board 530, a sensing chip 534, a lens barrel 542 and a holder 544. Optical elements, such as lens, diaphragm, and filter are received in the barrel 542. The barrel 542 is engaged with the holder 544 by threads. The flexible printed circuit board 530 has a first connecting portion 531 and a second connecting portion 532. The first connecting portion 531 is connected to a system circuit of an electronic device (not shown). The sensing chip 534 is connected with the second connecting portion 532 electrically and structurally. The sensing chip 534 receives light signals and converts the light signals into electrical signals. The electrical signals are then transferred to the system circuit of the electrical device by the flexible printed circuit board 530.

However, as mentioned above, the flexible printed circuit board 530 is needed for connecting the sensing chip 534 and the system circuit of the electrical device. This increases cost and size of the camera module.

What is needed, therefore, is to provide a camera module with low cost and small size.

### SUMMARY

In a present embodiment, a camera module configured to connect to an outer circuit board includes a lens barrel, a holder and a sensing chip. The holder has a first end, an opposite second end. The first end defines a cavity therethrough, and the lens barrel is engaged in the cavity of the first end. The second end defines an opening communicating with the cavity. The sensing chip is attached to the second end thereby sealing the opening defined by the second end. The sensing chip has a back surface away from the first end of the holder, and the back surface is provided with a plurality of welding spots configured for connecting the sensing chip to the outer circuit board electrically and structurally.

In another present embodiment, a camera module assembly includes a circuit board, a holder, a lens barrel and a sensing chip. The holder is attached to the circuit board. The holder includes a first end and an opposite second end, the first end defining a cavity therethrough, the second end defining an opening communicating with the cavity. The lens barrel is telescopically received in the cavity of the first end of the holder, at least a lens secured in the lens barrel. The sensing chip is attached to the second end to seal the opening of the second end. The sensing chip includes a light-receiving surface facing the at least one lens and a back surface away from the at least one lens. A plurality of welding spots are disposed between the back surface and the circuit board to connect the sensing chip with the circuit board electrically and structurally.

Advantages and novel features will become more apparent from the following detailed description of the present camera module, when taken in conjunction with the accompanying drawings.

### BRIEF DESCRIPTION OF THE DRAWINGS

Many aspects of the present camera module can be better understood with reference to the following drawings. The components in the drawings are not necessarily drawn to scale, the emphasis instead being placed upon clearly illustrating the principles of the present camera module. Moreover, in the drawings, like reference numerals designate corresponding parts throughout the several views.

FIG. 1 is a cross-section view of a camera module according to a first present embodiment;

FIG. 2 is a assembled isometric view of the camera module shown in FIG. 1;

FIG. 3 is a cross-section view of a camera module according to a second present embodiment; and

FIG. 4 is a disassembled isometric view of a typical camera module.

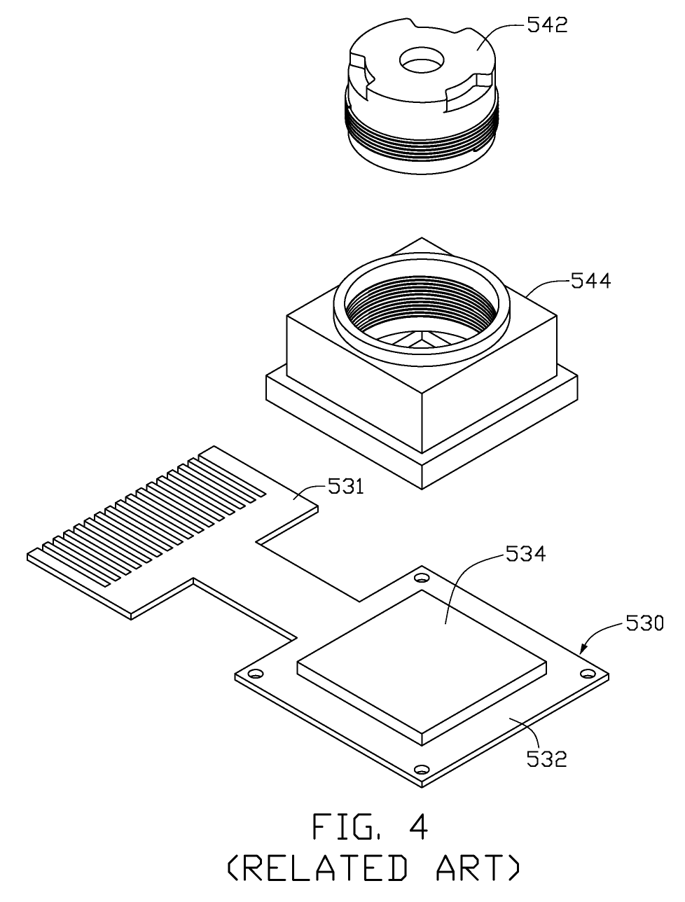

Corresponding reference characters indicate corresponding parts throughout the drawings. The exemplifications set out herein illustrate at least one present embodiment of the present camera module, in one form, and such exemplifications are not to be construed as limiting the scope of the invention in any manner.

### DETAILED DESCRIPTION OF THE INVENTION

Reference will now be made to the drawings to describe present embodiments of the camera module.

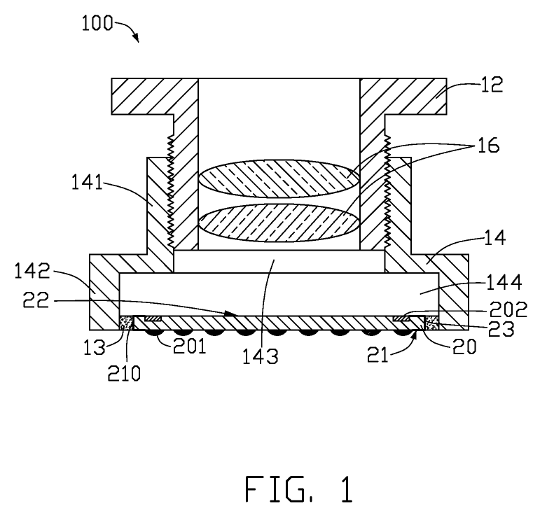

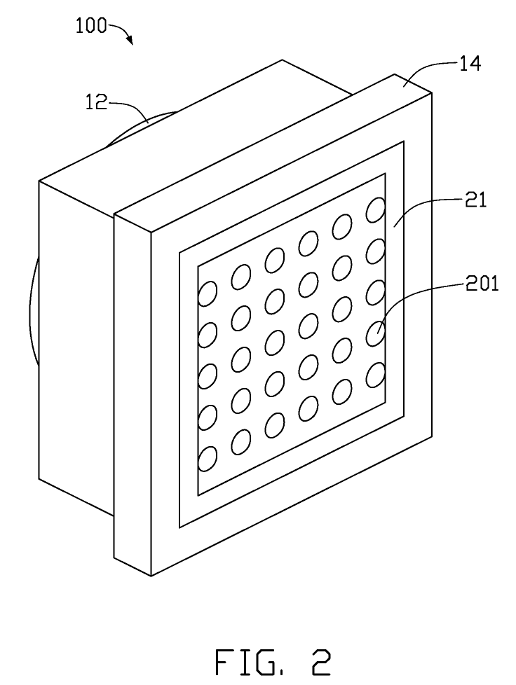

In FIGS. 1 and 2, a camera module 100 according to a first present embodiment is shown. The camera module 100 includes a lens barrel 12, lens group 16, a holder 14, and a sensing chip 20. Preferably, the sensing chip 20, the lens barrel 12, the lens group 16 and the holder 14 are made of refractory material. The lens group 16 is received in the lens barrel 12. The lens group 16 covers an efficient sensing area of the sensing chip 20. In this present embodiment, the lens group 16 includes two optical lenses. Alternatively, the lens group 16 may include one optical lens or more than two optical lenses. Other optical elements, such as, a filter or/and glass plate (not shown) may be disposed between the sensing chip 20 and the lens group 16. The optical elements may be attached to the sensing chip 20 or fixed inside the holder 14.

The holder 14 includes a first end 141, an opposite second end 142. The first end 141 defines a cavity 143 therein. The cavity 143 extends through the first end 141 in an axial direction thereof. The first end 141 has threads defined on an inner wall surrounding the cavity 143, and the lens barrel 12 has threads defined on an outer wall thereof, thereby the lens barrel 12 is capable of being received in the cavity and engaged with the inner wall of the first end 141 by threading. The second end 142 defines an opening 144 communicating with the cavity 143.

The sensing chip 20 is attached to the second end 142 by glue 13 thereby sealing the opening 144 defined by the second end 142. In this present embodiment, the sensing chip 20 is received in the opening 144 and surrounded by an inner wall of the second end 142. The glue 13 is provided between an outer periphery of the sensing chip 20 and the inner wall of the second end 142.

The sensing chip 20 is a CCD (coupled-charge device) sensing chip or a CMOS (complementary metal-oxide semiconductor) sensing chip for converting light signals to electrical signals. The sensing chip 20 has a light-receiving surface 22 and a back surface 21 opposite to the light-receiving surface 22 and away from the first end 141 of the holder 14. The light-receiving surface 22 faces the lens group 16 and receives light passing through the lens group 16, and the light-receiving surface 22 is provided with a plurality of welding pads 202. The back surface 21 is provided with a plurality of welding spots 201. The plurality of welding pads 202 are connected to the plurality of welding spots 201 by wires 23. In this present embodiment, each welding spot 201 is a bonding pedestal, and the plurality of welding spots 201 are arranged in a matrix form on the back surface 21 of the sensing chip 20.

When assembling the camera module 100 on an outer circuit board (not shown), the back surface 21 of the sensing chip 20 is preheated so as to soften the plurality of welding spots 201, and then the sensing chip 20 is electrically and structurally connected to the outer circuit board by the plurality of welding spots 201 after solidifying the plurality of welding spots 201. In this way, the camera module 100 is fixedly formed on the outer circuit board directly. Therefore, requirements of low cost and small size of the camera module 100 are achieved.

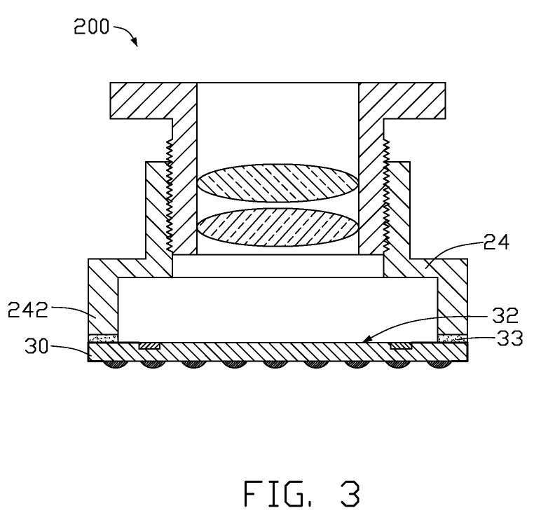

Referring to FIG. 3, a camera module 200 according to a second present embodiment is shown. The differences between the camera module 200 of the second present embodiment and the camera module 100 of the first present embodiment are that the second end 242 of the holder 24 is arranged on the light-receiving surface 32 of the sensing chip 30, and the glue 33 is provided between the light-receiving surface 32 of the sensing chip 30 and the distal end surface of the second end 242.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A camera module configured to connect to an outer circuit board, comprising:
a lens barrel;
a holder having a first end, an opposite second end, the first end defining a cavity therethrough, the lens barrel being engaged in the cavity of the first end, the second end defining an opening communicating with the cavity; and
a sensing chip attached to the second end thereby sealing the opening defined by the second end, the sensing chip having a back surface away from the first end of the holder, and the back surface being provided with a plurality of welding spots configured for connecting the sensing chip to the outer circuit board electrically and structurally.

2. The camera module as claimed in claim 1, further comprising at least one lens received in the lens barrel.

3. The camera module as claimed in claim 2, wherein the sensing chip, the lens barrel, the at least one lens and the holder are made of refractory material.

4. The camera module as claimed in claim 2, wherein the sensing chip has a light-receiving surface facing the at least one lens and being provided with a plurality of welding pads, and the plurality of welding pads connects to the plurality of welding spots by electrically conductive wires.

5. The camera module as claimed in claim 1, wherein each welding spot is a bonding pedestal or a solder ball.

6. The camera module as claimed in claim 1, wherein the plurality of welding spots are arranged in a matrix form on the back surface of the sensing chip.

7. The camera module as claimed in claim 1, wherein the first end of the holder has threads defined on an inner wall surrounding the cavity, the lens barrel has threads defined on an outer wall thereof and configured to engage with the threads of the first end of the holder, whereby the lens barrel threadedly engages with the inner wall of the first end of the holder.

8. The camera module as claimed in claim 1, wherein the sensing chip is received in the opening of the second end and surrounded by an inner wall of the second end, and a glue is provided between an outer periphery of the sensing chip and the inner wall of the second end.

9. The camera module as claimed in claim 4, wherein the second end of the holder is arranged on the light-receiving surface of the sensing chip, and a glue is provided between the light-receiving surface of the sensing chip and the second end.

10. A camera module assembly comprising:
a circuit board;
a holder attached to the circuit board, the holder comprising a first end and an opposite second end, the first end defining a cavity therethrough, the second end defining an opening communicating with the cavity;
a lens barrel telescopically received in the cavity of the first end of the holder, at least a lens secured in the lens barrel; and
a sensing chip attached to the second end to seal the opening of the second end, the sensing chip comprising a light-receiving surface facing the at least one lens and a back surface away from the at least one lens, a plurality of welding spots being disposed between the back surface and the circuit board to connect the sensing chip with the circuit board electrically and structurally.

11. The camera module assembly as claimed in claim 10, wherein the welding spots are disposed on the back surface by surface mounting technology, and connected to the circuit board after being soften and then solidified.

12. The camera module assembly as claimed in claim 10, wherein the sensing chip is received in the opening of the second end and surrounded by an inner wall of the second end, and a glue is provided between an outer side wall of the sensing chip and the inner wall of the second end of the holder.

13. The camera module assembly as claimed in claim 10, wherein the second end of the holder is disposed on the light-receiving surface of the sensing chip, and a glue is provided between the light-receiving surface of the sensing chip and the second end.
